(19) United States
(12) Patent Application Publication
(10) Pub. No.: US 2011/0001975 A1
(43) Pub. Date: Jan. 6, 2011

(54) Cavity Plasmon Resonance Biosensing Device, Method And System

(75) Inventors: Daniel Razansky, Brighton, MA (US); Pinchas Einziger, Haifa (IL); Dan Adam, Haifa (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: Technion Research & Development Foundation Ltd., Haifa (IL)

(21) Appl. No.: 11/849,616

(22) Filed: Sep. 4, 2007

Related U.S. Application Data
(63) Continuation-in-part of application No. PCT/IL2007/001004, filed on Aug. 12, 2007.

(51) Int. Cl. G01N 21/55

(52) U.S. Cl. 356/445

(57) ABSTRACT

The current invention provides a devices methods and systems for efficient biosensing using the Surface Plasmon Resonance (SPR) and Cavity Plasmon Resonance (CPR) phenomena. The miniature biosensor comprises a stratified structure having a channel for analyte form between a substrate and thin metallic absorber layer in which plasmon are resonantly excited. Presence of analyte in the channel, changes the resonance conditions, thus changing the energy absorbed by the biosensor. Bolometric signal from the absorber; layer or detection of the radiation not absorbed by the biosensor is used to detect, measure the concentration of, or monitor the analyte.

### FIELD OF THE INVENTION

The present invention relates to novel biosensing system using the Cavity Plasmon Resonance (CPR) phenomenon.

### BACKGROUND OF THE INVENTION

Biosensing based on Surface Plasmon Resonance (SPR) excitation in thin metallic films has already demonstrated unprecedented performance in label-free real-time probing of various biopolymer, ligand, protein, and DNA interactions.

Since its inception in the late sixties, the basic physical phenomenon underlying the SPR biosensing remained unchanged, namely, resonant absorption of TM-polarized light incident upon a metallic nano-film above the critical total internal reflection angle.

Since the SPR field is strictly confined to the metal-analyte interface, the measurements are usually limited to molecular adsorbates located in an immediate vicinity of this surface.

In addition to its use in biosensing, surface plasmon resonance phenomenon has previously also been applied to other imaging applications, such as evanescent wave two-dimensional imaging, near-field and far-field optical microscopy, and evanescent wave holography.

U.S. Pat. No. 6,344,272 entitled “Metal nanoshells” to Oldenburg, et al; Filed: Mar. 11, 1998 discloses particulate compositions and methods for producing them that can absorb or scatter electromagnetic radiation. The particles are homogeneous in size and are comprised of a nonconducting inner layer that is surrounded by an electrically conducting material. Introducing an optically absorbing species into the core will strongly influence the plasmon resonance shift and width. These nanoparticles could be used to sensitize existing photovoltaic, photoconductive, or bolometric cells.

Also, the thermal detection of surface plasmons was previously suggested.

U.S. Pat. No. 6,344,272 entitled “Metal nanoshells” to Oldenburg, et al; Filed: Mar. 11, 1998 discloses particulate compositions and methods for producing them that can absorb or scatter electromagnetic radiation. The particles are homogeneous in size and are comprised of a nonconducting inner layer that is surrounded by an electrically conducting material. Introducing an optically absorbing species into the core will strongly influence the plasmon resonance shift and width. These nanoparticles could be used to sensitize existing photovoltaic, photoconductive, or bolometric cells.

U.S. Pat. No. 7,193,703; entitled “Sensor unit for assay in utilizing attenuated total reflection” to Hakamata, et al; filed Jan. 3, 2006; discloses a sensor unit for assay in biochemical field.

The sensor has recess in prism and enclosing cover, for constituting flow channel for flow of sample fluid on sensing surface in form closed by securing enclosing cover to prism. The surface plasmon resonance sensor unit includes a thin film having a first surface and a sensing surface. The first surface overlies the prism to constitute a thin film/prism interface. The sensing surface immobilizes a sample in sample fluid. Illuminating light is applied to the interface in a form satisfying a condition for total internal reflection, to create attenuated total reflection in the illuminating light reflected by the interface. An angle of incidence of the illuminating light upon the attenuated total reflection is changed upon (bio)chemical reaction of the sample on the sensing surface.

U.S. Pat. No. 4,889,427; entitled “Method and apparatus for detecting low concentrations of (bio) chemical components present in a test medium using surface plasmon resonance”; to Van Veen, et al; filed Apr. 11, 1988; discloses a low concentration detection method for bio-chemical components which uses adjustable selector applied to metal layer for influencing incidence angle position of resonance curve.

### REFERENCES

[1] Liedberg B, Nylander C., and Lundstrom I, “Biosensing with surface plasmon resonance—how it all started”, 1995. Biosensors and Bioelectronics, 10(8), i-ix.

[2] Chien F.-C. and Chen S.-J., “A sensitivity comparison of optical biosensors based on four different surface plasmon resonance modes”, 2004. Biosensors and Bioelectronics, 20(3), 633-642.

[3] Homola. J, Yee S. S., and Gauglitz G., “Surface Plasmon resonance sensors: review”, 1999. Sensors and Actuators B, 54, 3-15.

[4] Kurihara, K.; Suzuki, K., “Theoretical Understanding of an Absorption-Based Surface Plasmon Resonance Sensor Based on Kretchmann's Theory”, 2002. Analytical Chemistry, 74(3), 696-701.

[5] Ho H. P., Law W. C, Wu S. Y., Lin C., and Kong S. K., Real-time optical biosensor based on differential phase measurement of surface plasmon resonance, 2005. Biosensors and Bioelectronics, 20(10), 2177-2180.

[6] Yeatman E. M., “Resolution and sensitivity in surface plasmon microscopy and sensing”, 1996. Biosensors and Bioelectronics, 11(6-7), 635-649.

[7] Ekgasit, S.; Thammacharoen, C.; Yu, F.; Knoll, W., “Evanescent Field in Surface Plasmon Resonance and Surface Plasmon Field-Enhanced Fluorescence Spectroscopies”, 2004. Analytical Chemistry, 76(8), 2210-2219.

[8] Specht, M.; Pedamig, J. D.; Heckl, W. M.; Hänsch, T. W., “Scanning plasmon near-field microscope”, 1992. Physical Review Letters, 68, 476-479.

[9] Smolyaninov, I. I.; Elliott, J.; Zayats, A. V.; Davis, C. C., “Far-field optical microscopy with a nanometer-scale resolution based on the in-plane image magnification by the surface plasmon polaritons”, 2005. Physical Review Letters, 94, 057401.

[10] Maruo, S.; Nakamura, O.; Kawata, S, “Evanescent-wave holography by use of surface-plasmon resonance”, 1997. Applied Optics, 36(11), 2343-2346.

[11] Raether, H., 1988. Surface Plasmon on Smooth and Rough Surfaces and on Gratings, Springer, Berlin.

[12] Razansky, D.; Einziger, P. D.; Adam, D. R., “Broadband absorption spectroscopy via excitation of lossy resonance modes in thin films”, 2005. Physical Review Letters, 95(1), 018101.

[13] Born M.; Wolf, E., 1999. Principles of Optics: Electromagnetic Theory of Propagation, Interference and Diffraction of Light, 7th ed., Cambridge University Press, Cambridge.

[14] Einziger, P. D.; Livshitz, L. M.; Mizrahi, J., “Rigorous image-series expansions of quasi-static Green's functions for regions with planar stratification”, 2002. IEEE Transactions on Antennas and Propagation, 50(12), 1813-1823.

[15] Weber, M. J. (editor), 2003. Handbook of Optical Materials, CRC Press, Boca Raton.

[16] Liu, X.; Cao, Z.; Shen, Q.; Huang, S., “Optical sensor based on Fabry-Perot resonance modes”, 2003. Applied Optics, 42(36), 7137-7140.

### SUMMARY OF THE INVENTION

Herein, we disclose a novel method of plasmon resonance excitation in nano-films, utilizing Cavity Plasmon Resonance (CPR) phenomenon. As compared to the classical TM-polarized SPR, the CPR, applicable for both TE and TM polarizations, does not require complicated evanescent field excitation conditions and offers very promising detection capabilities with respect to highly-sensitive real-time probing of bulk analytes in a variety of frequency bands.

One aspect of the invention is to provide a method of designing optimized plane-stratified biosensing devices with higher sensitivity and applicability in ultraviolet, visible, infrared, and other short wavelength electromagnetic spectra such as sub-millimeter and millimeter waves.

Another aspect of the current invention is to provide a plane-stratified biosensing element device utilizing plasmon resonance phenomena, such as Surface Plasmon Resonance (SPR) and Cavity Plasmon Resonance (CPR), for achieving high performance. Improved performances may include good frequency sensitivity, wide tunability over both infrared and visible light domains; bulk volume sensing capabilities; and high responsivity and miniaturization capabilities. Both CPR and SPR occur in metallic films, which are characterized by high thermal diffusivity essential for fast bolometric response.

Another aspect of the invention is to provide a method of designing a plane-stratified biosensor element device utilizing plasmon resonance phenomenon. The present invention provides a design method for optimization of sensing capabilities using metallic and other conducting films. It also discloses exploiting the effect of plasmon resonance absorption of electromagnetic radiation in metallic films for sensing using thermal (bolometric) detection of the absorbance variations of the metallic film due to plasmon resonance shifts. Surface plasmon detection has previously been applied to various SPR biosensing and other imaging applications, such as evanescent wave two-dimensional imaging (reference [5]), near-field (reference [6]) and far-field optical microscopy (reference [7]). However, thermal detection of plasmon resonance shifts for biosensing applications has not yet been proposed.

Another aspect of the invention is to provide a stratified biosensor element device utilizing conducting (non-metallic) bolometric materials such as thin films of vanadium dioxide (VO₂) in its semimetal state, bismuth (Bi), carbon (C), and tellurium (Te). Alternatively, metals such as silver, gold, aluminum, and copper may be used. In contrast to microbolometric elements of the art, the stratified biosensor element device according to the aspect of the invention achieves higher power absorption efficiency within said thin films. In some embodiments cooling requirements are minimized or eliminated due to the high sensitivity of the microsensor element having high energy/power absorption.

In this invention, we explore optimal absorption by plane-stratified sensing elements and outline an approach for the characterization of optimal materials and structures that may provide total absorption of the incident electromagnetic radiation. Particularly, we propose to utilize cavity plasmon resonance phenomenon for design of highly efficient detection element incorporating thin noble metal films. We also describe the phenomenon of Cavity Plasmon Resonance (CPR) that, like the well-known Surface Plasmon Resonance (SPR), occurs in metallic films.

Another aspect of this invention suggests using the resonant nature of the CPR phenomenon in order to replace the currently wide-spread Surface Plasmon Resonance (SPR) spectroscopy/biosensing techniques. SPR spectroscopy has demonstrated unprecedented performance in label-free real-time probing of various biopolymer, ligand, protein, and DNA interactions. Since its inception in the late sixties, the basic physical phenomenon underlying the SPR biosensing remained unchanged, namely, resonant absorption of TM-polarized light incident upon a metallic nanofilm above the critical total internal reflection angle. Since the SPR field is strictly confined to the metal-analyte interface, the measurements are usually limited to molecular adsorbates located in an immediate vicinity of this surface.

In contrast to the classical SPR, that requires very specific excitation conditions, which could be disadvantageous in some practical designs, the CPR does not require complicated evanescent field excitation conditions above the critical total internal reflection angle and may be implemented for both transverse electric (TE) and transverse magnetic (TM) fields even under normal incidence (TEM). These and other unique features of CPR enable a more flexible design of not only highly efficient thermal detector (bolometric) elements but also a new, highly-sensitive and flexible biosensing and spectroscopic devices.

In some embodiments, a novel method of plasmon resonance excitation in nanofilms, utilizing cavity plasmon resonance (CPR) is provided. Specifically, the method is useful for detection of small quantities of organic material such as needed in bio-sensing.

In one aspect of the invention, a stratified sensor for monitoring analytes is provided comprising: a substrate; an absorbing film for absorbing incoming radiation by excitation of plasmon in said absorbing film, and converting said absorbed radiation to heat, wherein plasmon resonance absorption of said radiation increases the fraction of radiation absorption by at least ten percents, wherein said substrate and said absorbing film are separated by a gap into which fluid analyte is inserted.

In some embodiments the gap between the absorbing film and the substrate acts as a resonance cavity.

In some embodiments the stratified sensor further comprising a reflector deposited on front surface of the substrate.

In some embodiments the stratified sensor further comprising a substantially transparent prism attached to the front surface of the absorbing film.

In some embodiments the plasmon resonance absorption increases the fraction of radiation absorption to at least ninety percents.

In some embodiments the plasmon resonance absorption increase is over a narrow range of wavelength.

In some embodiments the plasmon resonance absorption increase is over a narrow range incoming beam angulations.

In some embodiments the absorbing film comprises material selected from the group of: vanadium dioxide, bismuth, carbon, tellurium; silver; gold; aluminum; and copper.

In some embodiments receptors for attaching molecules dissolved in analyte are deposited on the surface of the absorbing film.

In another aspect of the invention, a method for monitoring analyte is provided comprising the step of: inserting analyte in a gap between a substrate and an absorbing film; resonantly exciting plasmons in said absorbing film by absorbing electromagnetic radiation; and detecting signal indicative of said absorbed radiation.

In some embodiments the step of detecting signal indicative of absorbed radiation comprises measuring temperature increase of the absorbing film caused by said absorbed radiation.

In some embodiments the step of detecting signal indicative of absorbed radiation comprises measuring radiation which was not absorbed.

In some embodiments the step of measuring radiation which was not absorbed comprises measuring reflected radiation.

In yet another aspect of the invention, an biosensing system for monitoring analyte is provided comprising: at least one stratified sensor comprising: a substrate; an absorbing film for absorbing incoming radiation by excitation of plasmon in said absorbing film, and converting said absorbed radiation to heat, wherein plasmon resonance absorption of said radiation increases the fraction of radiation absorption by at least ten percents, wherein said substrate and said absorbing film are separated by a gap into which fluid analyte is inserted; a radiation source for generating said incoming radiation; and data acquisition unit receiving signals from said at least one stratified sensor.

In some embodiments the biosensing system further comprises an array of stratified sensors.

In some embodiments an array of stratified sensors comprises of substantially unequal sensors.

In some embodiments the substantially unequal sensors are responsive to different narrow wavelength ranges.

In some embodiments the substantially unequal sensors are responsive to different narrow angular ranges.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 schematically depicts an isometric view of a microsensor element according to an embodiment of the current invention.

FIG. 1(b).i schematically depicts a side view of a microsensor element with integrated electronics according to an embodiment of the current invention.

FIG. 1(b).ii schematically depicts a side view of a microsensor element with a mirror according to an embodiment of the current invention.

FIG. 1(b).iii schematically depicts a side view of a microsensor element with a prism according to an embodiment of the current invention.

FIG. 1(c) schematically depicts a top view of 2D microsensors array according to an embodiment of the current invention.

FIG. 1(d) schematically depicts the general N-layer model of a microsensor according to an embodiment of the current invention.

FIG. 1(e) schematically depicts a cross section of a microsensor element configured in Surface Plasmon Resonance (SPR) configuration according to an embodiment of the current invention and shows the field distribution within its layers.

FIG. 1(f) schematically depicts a cross section of a microsensor element configured in Cavity Plasmon Resonance (CPR) configuration according to an embodiment of the current invention and shows the field distribution within its layers.

FIG. 1(g) schematically depicts a cross section of a miniature bio-sensing element configured in Surface Plasmon Resonance (SPR) configuration according to an embodiment of the current invention.

FIG. 1(h) schematically depicts a cross section of a miniature bio-sensing element configured in Cavity Plasmon Resonance (CPR) configuration according to an embodiment of the current invention.

FIG. 2 schematically depicts the optimal absorption paths for various total absorption cases and intersection points with some material dispersion curves.

FIG. 3(a) schematically depicts the power absorption efficiency in the vicinity of various lossy resonances showing the efficiency η versus excitation wavelength λ=c/f.

FIG. 3(b) schematically depicts the power absorption efficiency in the vicinity of various lossy resonances showing the efficiency η versus angle of incidence θ₁.

FIG. 4. schematically depicts the normalized LRM field distributions E_{q}/Eᵢ (q=2,3) versus normalized location z/d.

FIG. 5. schematically depicts the effect of analyte losses on the Fabry-Perot sensing configuration showing the difference between water, for which the losses were completely neglected, and analyte inclusion having slight attenuation at the operating wavelength, which leads to elimination of the resonant behavior in the reflectance spectra of the micro biosensor according to the current invention.

FIG. 6(a) schematically depicts an observation system using a micro biosensor according to an embodiment of the current of the current invention.

FIG. 6(a) schematically depicts an observation system using a micro biosensor according to another embodiment of the current of the current invention.

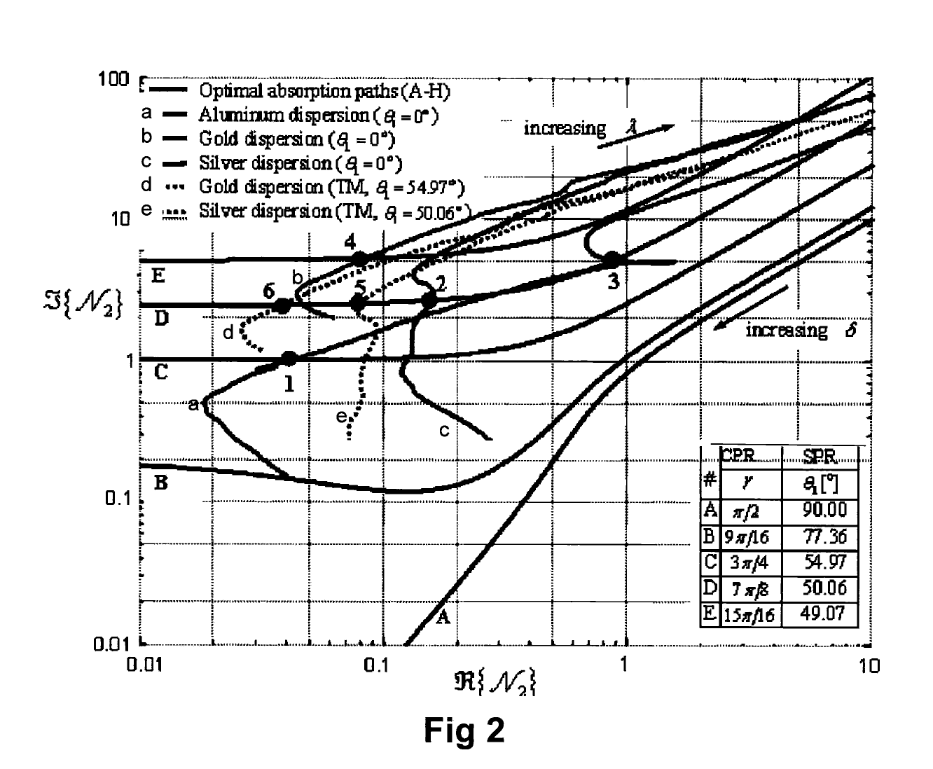

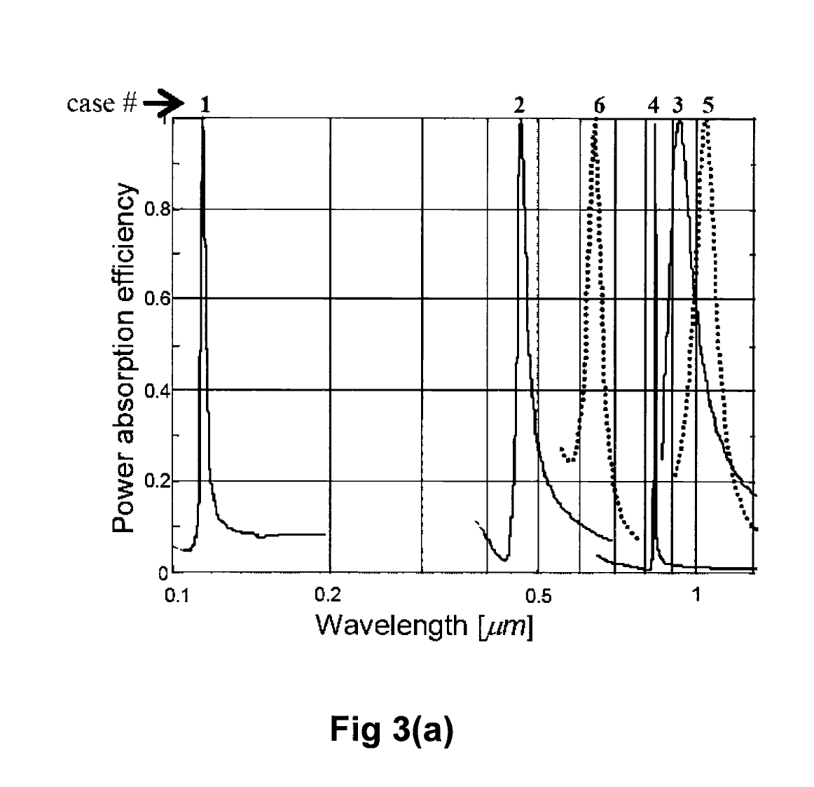

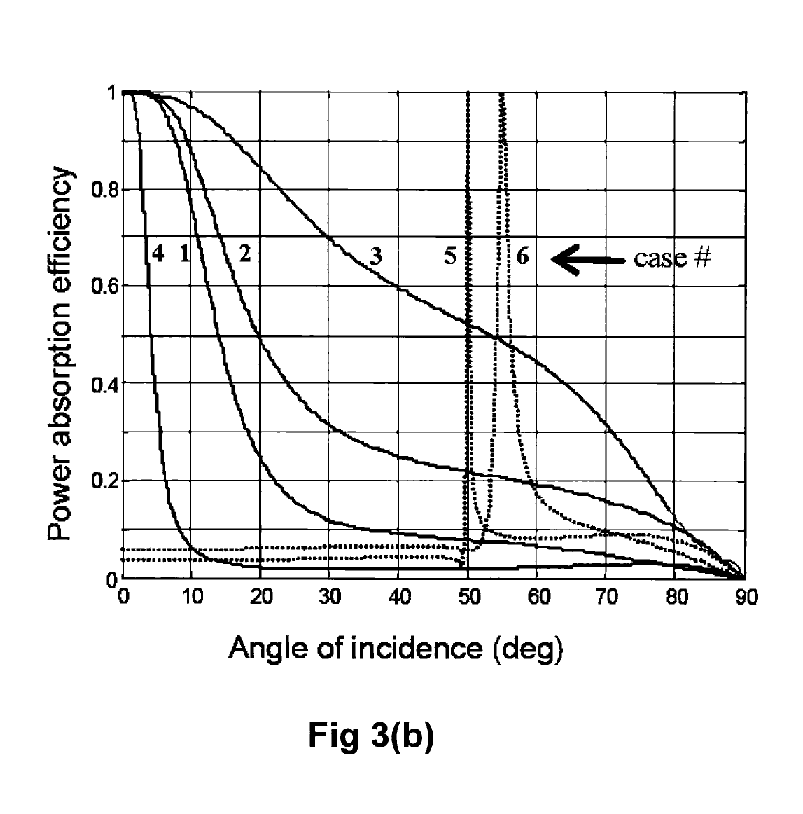

Table 1. depicts the configuration parameters for intersection (full absorption) points, as depicted in FIGS. 2 and 3, respectively wherein the sensitivity and resolution are calculated as in reference [3].

### DESCRIPTION OF THE PREFERRED EMBODIMENTS

The present invention relates to devices, methods and systems for highly efficient biosensor.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In discussion of the various figures described herein below, like numbers refer to like parts. The drawings are generally not to scale. For clarity, non-essential elements were omitted from some of the drawings.

Some optional elements may be drawn in dashed lines.

As used herein, an element or step recited in the singular and proceeded with the word “a” or “an” should be understood as not excluding plural elements or steps, unless such exclusion is explicitly recited.

### I. Construction of a Microsensor Element

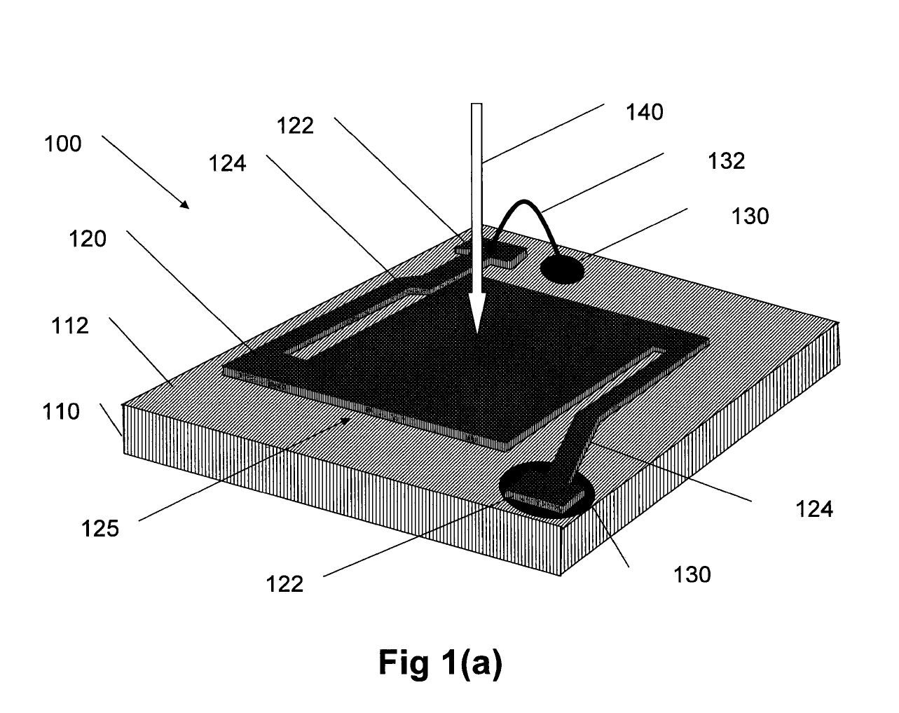

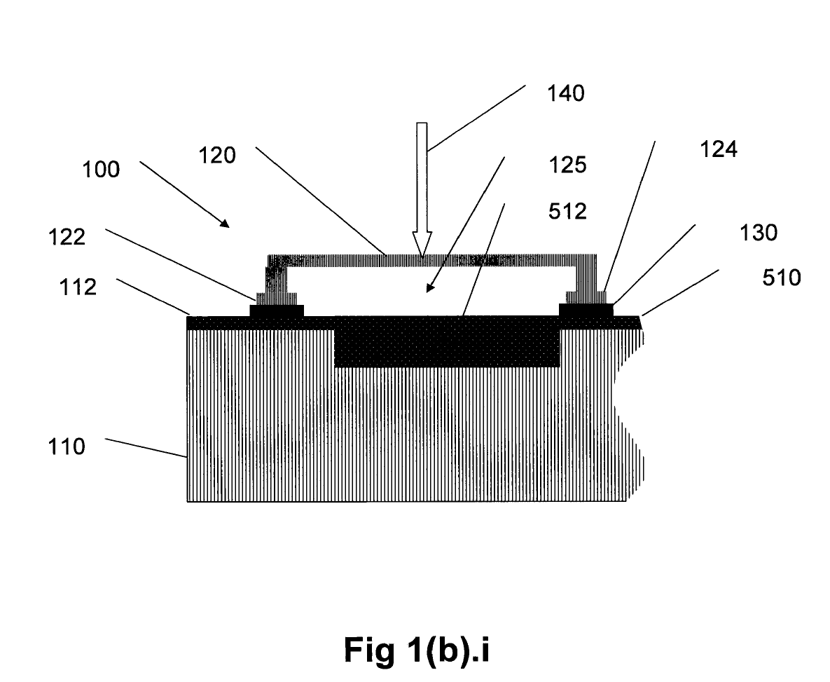

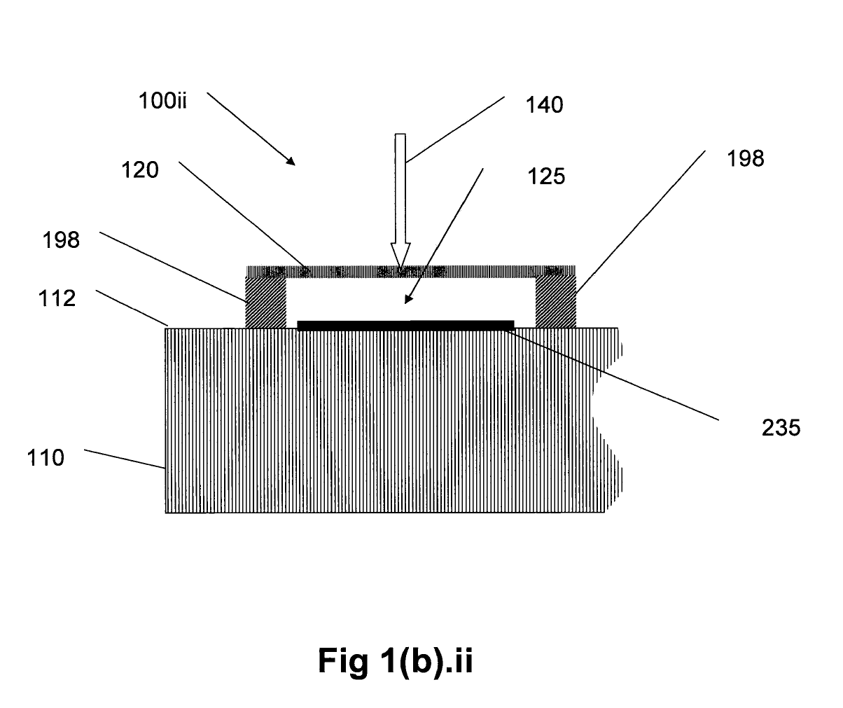

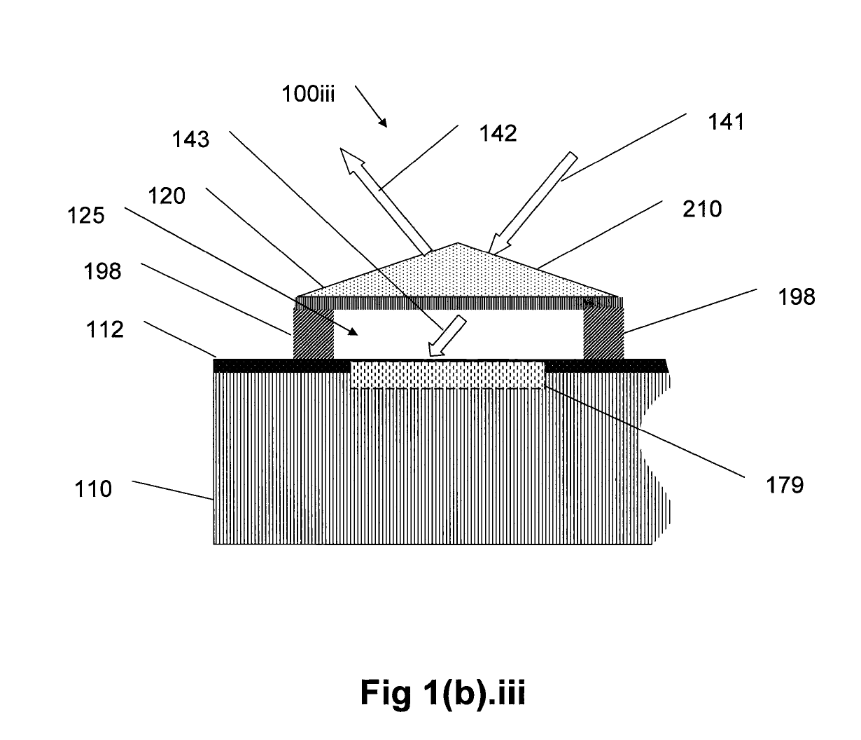

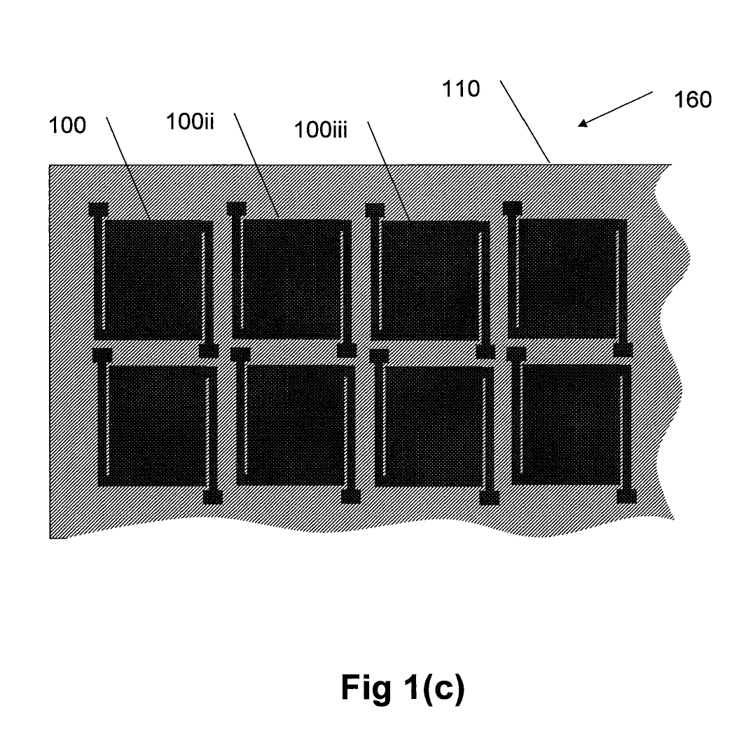

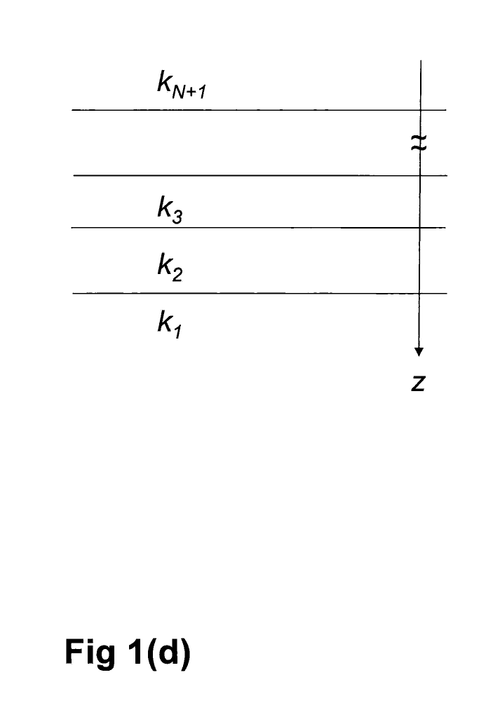

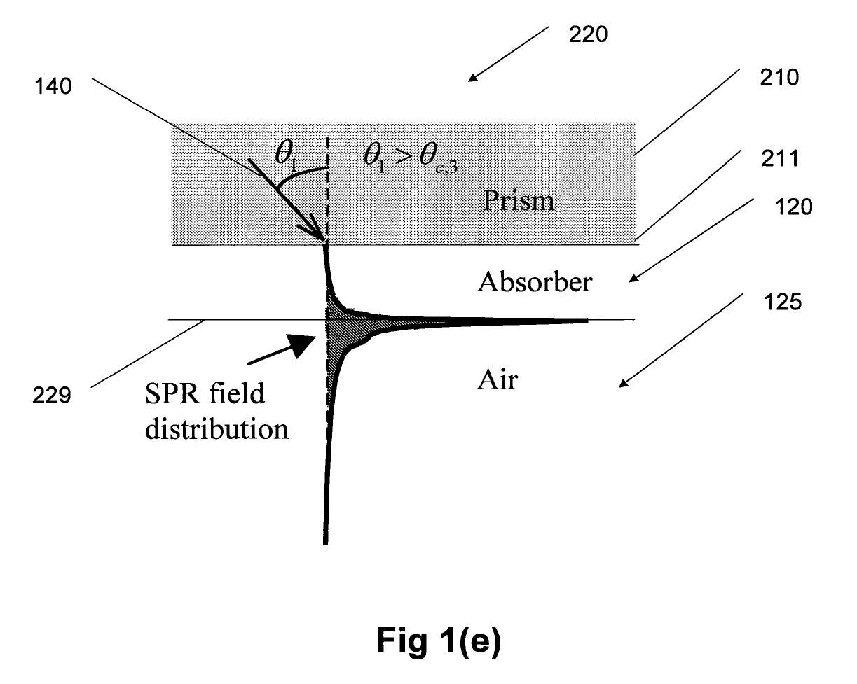

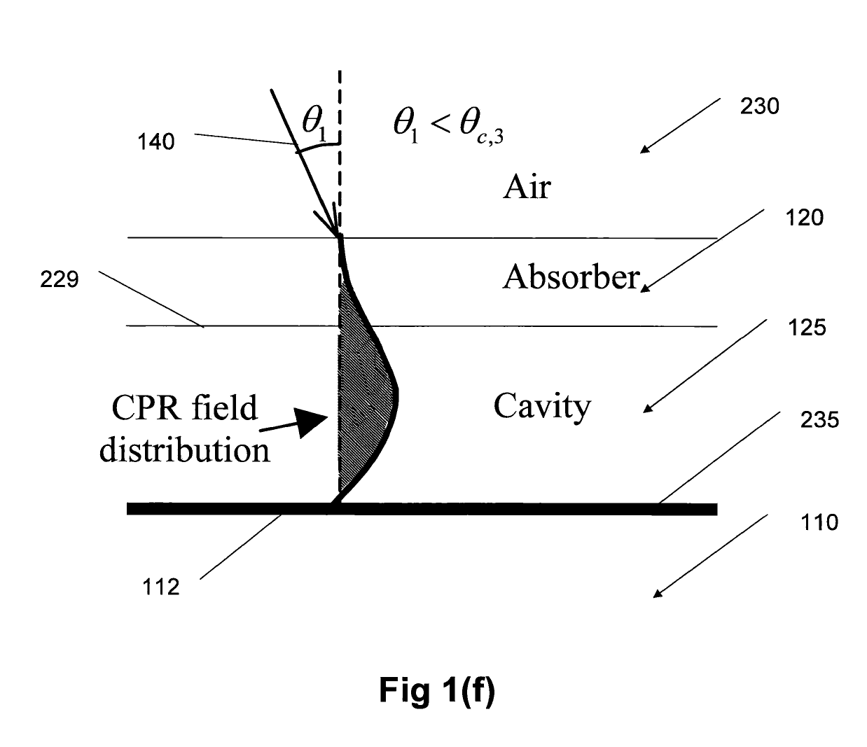

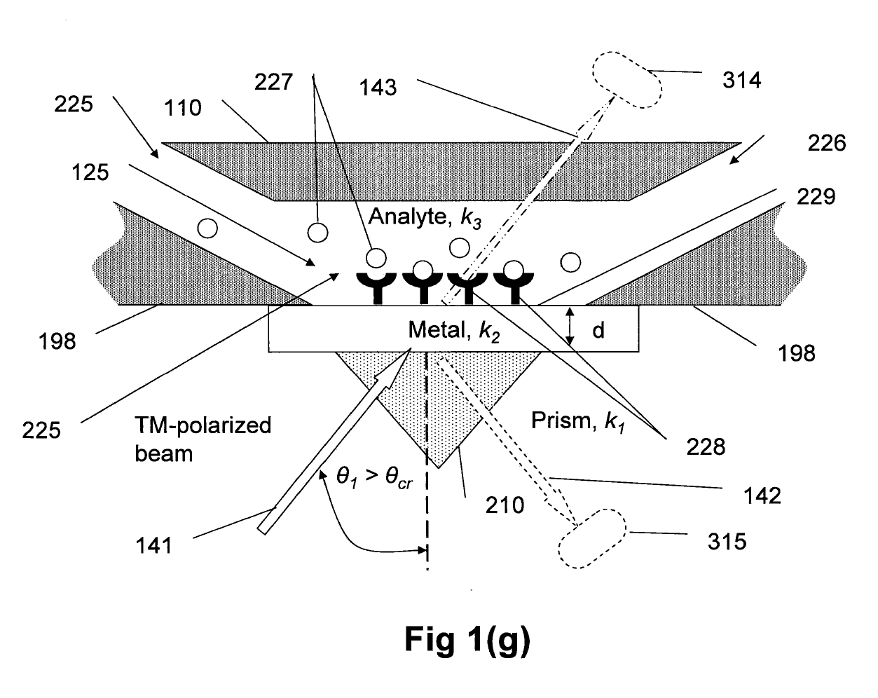

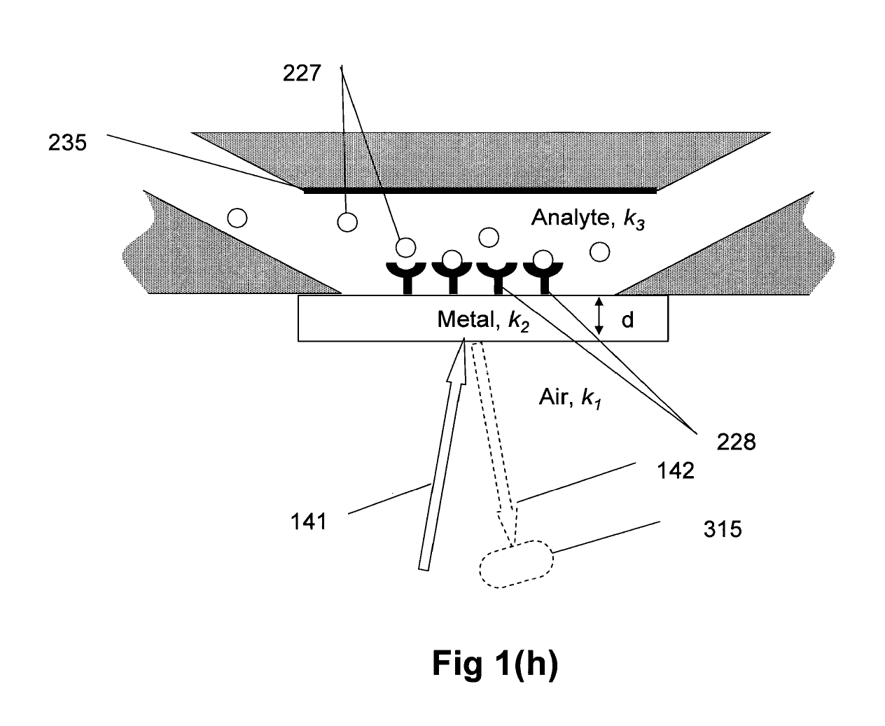

FIG. 1 schematically depicts an isometric view of a microsensor element detector according to an embodiment of the current invention.

Microsensor element 100 comprises a substrate 110 having a front surface 112. Absorbing film 120 is attached to front surface 112 at anchors 122.

Preferably, leads 124 are used for lifting or holding absorbing film 120 above the front surface 112 of substrate 110 creating a gap 125 therebetween. Optionally, leads 124 acts to reduce heat transfer between absorbing film 120 and substrate 110, thus increasing the sensor's sensitivity. Preferably leads 124 acts as electrical connections for electrical signals indicative of temperature of absorbing film 120. For example, anchors 122 may be attached to electronic pads 130 on substrate 110. Alternatively, wire bond 132 is used for connecting anchors 122 to electronic pads 130. Alternatively or additionally, spacers (not shown in this figure) may be used for defining the distance between absorbing film 120 and front surface 112. According to this aspect of the invention, microsensor element 100 acts as a sensitive and specific bolometer.

Substrate 110 preferably comprises of electrical conductors for transmitting electronic signals from detector 100 to signal conditioning circuits and data acquisition system. Optionally, substrate 110 comprises of semi-conductor material such as Silicon, Germanium or Gallium Arsenide. Optionally, active signal conditioning circuits are integrated into substrate 110. Alternatively, substrate 100 may be a passive substrate. Passive substrate may be made of insulating material such as glass, ceramics, plastic etc. Preferably, passive substrate includes conductive lines, preferably created using printed circuits technology.

Front surface 112 may be optically smoothed and act as a total or partial optical reflector. Optionally, an optical layer, such as metal reflector, dielectric anti-reflection coating; or dielectric mirror may be coated on top of front surface 112.

Incoming radiation 140 is impinges on, and at least partially absorbed by absorbing film 120 causing temperature increase of said absorbing film 120.

Microsensor element 100 may be fabricated using microelectronics and micromachining techniques.

The embodiments of FIGS. 1(a) and 1(b) are preferred when the microsensor element is used as a bolometer. However, as will be shown in other drawings, the same or similar construction may be used as microsensor in which signals are derived not from the conversion of the radiation to heat, but from signals derived from radiation not absorbed, that is radiation reflected from, or transmitted through the absorber layer. It should be noted that combination of said signals (absorbed, reflected and transmitted radiation) may be used. Using combination of two or three signals may enhance the Signal to Noise Ratio (SNR), thus enhancing the sensitivity of the microsensor.

FIG. 1(b).i schematically depicts a side view a micro sensor with integrated electronics according to an exemplary embodiment of the current invention.

Microsensor element (in bolometric detector configuration) 100 comprises a substrate 110 having a front surface 112. Absorbing film 120 is attached to front surface 112 at anchors 122. Optionally, leads 124 are used for lifting absorbing film 120 above the front surface 112 of substrate 110 creating gap 125. Optionally, leads 124 acts to reduce heat transfer between absorbing film 120 and substrate 110, thus increasing the sensor's sensitivity. Preferably leads 124 acts as electrical connections for electrical signals indicative of temperature of absorbing film 120. For example, anchors 122 may be attached to electronic pads 130 on substrate 110.

Optionally, substrate 110 comprises of semi-conductor material such as Silicon, Germanium or Gallium Arsenide. Optionally, active signal conditioning circuits 512 are integrated into substrate 110. Substrate 110 preferably comprises of electrical conductors 510 for transmitting electronic signals from detector 100 to signal conditioning circuits 512.

Incoming radiation 140 is impinges on, and at least partially absorbed by absorbing film 120 causing temperature increase of said absorbing film 120.

It should be noted that radiation reflected from microsensor 100 may be monitored. Specifically, a maximum(s) in absorbed radiation generally coincide with minimum(s) in the reflected radiation.

Gap 125 may used as a channel for flow of liquid or gas for analysis.

In some embodiments, capillary action draws liquid to be analyzed into gap 125.

FIG. 1(b).ii schematically depicts a side view a micro sensor with mirror according to an exemplary embodiment of the current invention.

Microsensor element 100ii comprises a substrate 110 having a front surface 112. A mirror 235 is deposited on front surface 112 below absorbing film 120. Mirror 235 may be metallic or dielectric. In this exemplary embodiment, absorbing film 120 is supported above and substantially parallel to front surface 112 by spacers 198 creating gap 125.

Optionally, leads (not shown here) are used for acts as electrical connections for electrical signals indicative of temperature of absorbing film 120. Optionally, substrate 110 comprises of semi-conductor material such as Silicon, Germanium or Gallium Arsenide. Optionally, active signal conditioning circuits are integrated into substrate 110.

Incoming radiation 140 is impinges on, and at least partially absorbed by absorbing film 120 causing temperature increase of said absorbing film 120.

Preferably, radiation reflected from microsensor 100ii may be monitored. Specifically, a maximum(s) in absorbed radiation generally coincide with minimum(s) in the reflected radiation.

Gap 125 may used as a channel for flow of liquid or gas for analysis.

FIG. 1(b).iii schematically depicts a side view a micro sensor with prism 100iii according to an exemplary embodiment of the current invention.

Microsensor element 100iii comprises a substrate 110 having a front surface 112.

In this exemplary embodiment, absorbing film 120 is supported above front surface 112 by spacers 198 creating gap 125. Prism 210 is attached to absorbing film 120. Optionally, absorbing film 120 is a metallic layer deposited on prism 210.

Optionally, leads (not shown here) are used for acts as electrical connections for electrical signals indicative of temperature of absorbing film 120.

Optionally, substrate 110 comprises of semi-conductor material such as Silicon, Germanium or Gallium Arsenide. Optionally, active signal conditioning circuits are integrated into substrate 110. Optionally, photo sensor such as photodiode 179 is placed under absorbing film 120. Preferably, optional photodiode 179 is integrated into substrate 110.

Incoming radiation 140 is impinges on prism 210, and at least partially absorbed by absorbing film 120 causing temperature increase of said absorbing film 120.

Preferably, reflected radiation 142, reflected from microsensor 100ii is monitored. Specifically, a maximum(s) in absorbed radiation generally coincide with minimum(s) in the reflected radiation.

Transmitted radiation 143 may be absorbed and monitored by photo sensor 179.

Optionally, active signal conditioning circuits are integrated into substrate 110. Said conditioning circuits may amplify and condition signals from photo sensor 179, absorbing film 120 or both.

Gap 125 may used as a channel for flow of liquid or gas for analysis.

FIG. 1(c) schematically depicts a top view of 2D microsensors array 160 according to an embodiment of the current invention.

Microsensors array 160 comprises substrate 110 and plurality of microsensors elements 100, 100ii or 100iii or combination thereof.

In some embodiments microsensor elements are substantially identical. In other embodiments, at least one of the detector elements has different construction. In some embodiments, each of the detector elements has unique construction. In other embodiments, elements in each row of elements are substantially identical.

Biosensors array 160 may be a two dimensional (2D) array as depicted in the FIG. 1(c). However, 1D array may be constructed. Other distributions of detector elements on the substrate, for example in form of concentric circles, arches, and even pseudo-random configuration are also possible.

It should be noted that dimensions of elements and their shape can vary.

In some embodiments gaps in microsensor elements are joined to create channel for fluid to be analyzed.

In an array of detectors, prism 210 may be an individual prism for each of the array elements. Optionally properties of prisms attached to different elements are not the same. Alternatively one prism may be attached to plurality or all the elements in the array. Prism 210 may be part of an optical system for manipulating the input beam. For example, prism 210 may have focusing or collimation properties for manipulating or limiting the range of input angles. Additionally or alternatively, prism 210 may have wavelength filtering properties for manipulating or limiting the range of wavelength of the input beam.

### II. Plane Stratified Sensing Model

Surface Plasmon Resonance (SPR) spectroscopy is known as one of the most sensitive wavelength biosensing and imaging method for characterization of surface physical properties of materials and adsorbates [1]-[5] and is exploited for monitoring DNA hybridization reactions, biochemical and immuno-sensing, as well as being explored for optical microscopy, sub-wavelength optics, and holography-based applications [6]-[10]. A common geometrical setup used for SPR biosensing applications (the Kretschmann's configuration [3]-[4]) is depicted in FIG. 1(d).

SPR device includes metallic nano-film placed between a high refractive index prism and the analyte under investigation. An electromagnetic (EM) radiation of wavelength within the visible or near-infrared spectrum, is beamed upon the film at above the total internal reflection angle θ_{cr}=sin⁻¹(k₃/k₁). Maximal sensitivity of the SPR is achieved whenever the film thickness is optimally selected so as to allow for full absorption conditions. The theoretical basis of SPR is now well established and described elsewhere [4]-[6], [11]. An important property of surface plasmons is the enhancement of the EM field at their interface, as compared to the impinging incoming radiation. This enhancement can reach a factor of about 10 for a smooth flat surface, and can reach even higher values for a rough surface [11]. This is one of the main properties that make surface plasmons useful for robust and highly sensitive surface-enhanced spectroscopy, like the surface plasmon fluorescent spectroscopy. The evanescent field associated with surface plasmons decay exponentially with the distance away from the metal-analyte interface. Being limited to near-plasma frequencies of metals, lying in the visible and near-infrared bands, surface plasmons can be excited under very specific conditions and usually have poor penetration depth into adsorbing layers. The resulting device is capable of measuring the refraction index of very thin layers of material attached to the metal.

Herein we disclose a method of plasmon resonance excitation by utilizing the cavity plasmon resonance (CPR) phenomenon. The basic CPR-supporting configuration is depicted in FIG. 1(h). SPR and CPR are both absorption refractometry methods, for which maximal sensitivity is achieved by obtaining the maximal possible quality factor of the resonance in the reflectivity (or absorption) spectra, per given configuration. Resonant full absorption conditions may also be referred to as the lossy resonance modes (LRM) of a layered medium [12]. In SPR, the maximal sensitivity is attained by optimally selecting the thickness of the metallic film as to allow full absorption and zero reflectivity. In this paper, we first propose a generalized optimization method for obtaining the optimal absorption conditions in multilayered biosensing configurations, from which a new type of plasmon resonance sensing, utilizing the CPR is subsequently derived.

The mathematical derivation is facilitated by considering the basic prototype model of a stratified medium (FIG. 1(d)) where a plane monochromatic electromagnetic wave, propagating in the −\hat{z} direction, obliquely incident upon the interface at z=z₁. The layers are characterized by their corresponding wave-numbers k_{g} (q=1, . . . , N+1) and assumed to have the permeability of free-space, i.e. μ_{q}=μ₀. The angles of wave propagation in all the layers are determined via Snell's law, k₁ sin θ₁=k₂ sin θ₂= . . . =k_{N+1} sin θ_{N+1}. The procedures for finding the field distribution in stratified media are described elsewhere [13], [14] leading to an explicit decomposition of the transversal electric field in each layer in terms of its forward and backward propagating components, i.e.

E_{q}=EᵢT_{q}(e^{ik}^{_{q}}^{z cos θ}^{_{q}}+R_{q}e^{-ik}^{_{q}}^{z cos θ}^{_{q}}), (1)

where Eᵢ denotes the incident transversal electric field. The global reflection and transmission coefficients R_{q} and T_{q} can be conveniently recovered through an iterative procedure [14], leading to

$$\begin{matrix}{R}_{q} = \frac{{r}_{q} + {R}_{q + 1} {e}^{- 2 i {k}_{q + 1} {z}_{q} c os {θ}_{q + 1}}}{1 + {r}_{q} {R}_{q + 1} {e}^{- 2 i {k}_{q + 1} {z}_{q} co s {θ}_{q + 1}}} {e}^{2 i {k}_{q } {z}_{q} co s {θ}_{q}} , \\ {R}_{N + 1} = 0 \\ and & ( 2 ) \\ {T}_{q } = {\prod }_{m = 2}^{q} \frac{( 1 + {r}_{m - 1} ) {e}^{i ( {k}_{m - 1} co s {θ}_{m - 1} - {k}_{m} co s {θ}_{m} ) {z}_{m - 1}}}{1 + {r}_{m - 1} {R}_{m} {e}^{- 2 i {k}_{m} {z}_{m - 1} co s {θ}_{m}}} , \\ {T}_{1} = 1 , & ( 3 )\end{matrix}$$

with the local refraction coefficients r_{q} and normalized refractive indexes N_{q} defined via

$${r}_{q} = \frac{{N}_{q} - {N}_{q + 1}}{{N}_{q} + {N}_{q + 1}} , {N}_{q}^{TE \\ TM} = \frac{{k}_{q}}{{k}_{1}} {( \frac{cos {θ}_{q}}{cos {θ}_{1}} )}^{\pm 1} , {r}_{N + 1} = 0. \qquad ( 4 )$$

The distinguishing superscripts ^{TE} and ^{TM}, corresponding to the two elementary plane-wave polarizations, have been partially omitted in Eqs. (1)-(4), only for relations applying to both polarizations. This rule is adapted throughout the paper for all the equations that apply to both polarizations.

The corresponding power absorption efficiency can be defined as a fraction of the incident power captured by the absorbing layer, i.e.,

η=1−|R₁|²−|T_{N+1}|² [symbol] {N_{N+1}}. (5)

It is further required for effective (high quality factor) plasmon resonance excitation that all the layers are nearly lossless except for the second layer, i.e. ℑ{k_{q}}0, q=1, 3, 4, . . . , N+1. We also refer to the maximum (full) absorption conditions, i.e. when η reaches its maximum or η=1, as Lossy Resonance Modes (LRM) of the layered medium. From (5) it can readily be noticed that full absorption (η=1) can be achieved if two conditions are satisfied, namely, (i) either T_{N+1}=0 or [symbol] {N_{N+1}}=0 and (ii) R₁=0. When T_{N+1}=0, i.e. r_{N}=−1 in (4), no energy penetrates into the substrate layer k_{N+1} and an equivalent lossy resonance cavity appears in the region z_{N}≦z≦z₁=0 due to a perfect mirror at z=z_{N} (FIG. 1(h) for N=3) and no reflection at z=z₁. Alternatively, the term [symbol] {N_{N+1}} vanishes when exciting evanescent plane waves in the region z≦z_{N}, which may lead to the classical SPR situation, depicted in FIG. 1(g) for N=2. It should be noted that while the basic SPR and CPR excitation is demonstrated here for three and four-layer configurations, respectively, inclusion of additional layers may provide an extra control over the sensing parameters, such as sensitivity, spatial and angular selectivity, bandwidth etc.

FIGS. 1(e) and 1(f) schematically depict cross sections of two novel structures for a microsensor according to the current invention.

FIG. 1(e) schematically depicts a cross section of a microsensor element configured in Surface Plasmon Resonance (SPR) configuration 220 according to an embodiment of the current invention and shows the field distribution within its layers.

Input beam entering 140 at angle θ₁ respective to the surface of absorber film 120. In this configuration, gap 125 is large compared to the extant of the SPR field distribution. Since the field does not substantially interact with the substrate, the substrate is not seen in this figure. Optionally, reflection from the substrate is reduced, for example by having substrate with low reflection coefficient; coating the substrate with low reflection coating, coating the substrate with anti reflection coating which causes large percentage of the radiation to be absorbed by the substrate; or having a substrate which scatters the light, for example by having rough surface.

Optional, substantially transparent material 210 affixed to front surface of absorptive film 211 and having index of refraction unequal to 1.0 (marked as “Prism” in the drawing) may be used for refractivity control the entrance angle θ₁ and affect the penetration of the radiation into the absorber film. Additionally, optional prism 210 may be used for supporting absorptive film 120, thus enabling the elimination of the substrate.

FIG. 1(f) schematically depicts a cross section of a microsensor element configured in Cavity Plasmon Resonance (CPR) configuration 230 according to an embodiment of the current invention and shows the field distribution within its layers.

Input beam entering 140 at angle θ₁ respective to the surface of absorber film 120. In this configuration, gap 125 forms an optical resonance cavity between absorber film 120 and mirror 235 on front surface 112 of substrate 110.

Preferably, mirror 235 is a high reflectance mirror. For example a metallic or dielectric coating on front surface 112 of substrate 110 may form a substantially “perfect mirror” having close to 100% reflectance for the input wavelength. However, reflectance of 95% or 90% may yield useful results.

From the electric field distributions depicted in FIGS. 1(e) and 1(f) it is apparent that the field is large near the surface of the absorbing film 120. However, in contrast to the field distribution of SPR depicted in FIG. 1(e) which is concentrated at the lower surface 229 of absorbing film 120, the field distribution of CPR depicted in FIG. 1(f) is substantial throughout most of gap 125.

Accordingly, while the sensor of FIG. 1(e) is most sensitive to molecules adsorbed at surface 229, while that of FIG. 1(f) is sensitive also to molecules dispersed within gap 125.

FIG. 1(g) schematically depicts a cross section of a miniature bio-sensing element configured in Surface Plasmon Resonance (SPR) configuration according to an embodiment of the current invention.

In this exemplary embodiment of SPR device, input channel 225 is used as input port for fluid analyte flow fluid analyte may than exit through exit channel 226.

Reactive molecules 227, dispersed or dissolved analyte 226 attach to receptors 228 attached to surface 229, thus affecting the optical properties of the device.

In this exemplary embodiment, substrate 110 is made of material transparent to wavelength of input radiation 141. Thus, in the event that some transmitted radiation 143 is transmitted through the device, it may be detected by optional transmitted radiation detector 314.

Similarly, reflected radiation 142 may be detected by optional reflected radiation 315.

FIG. 1(h) schematically depicts a cross section of a miniature bio-sensing element configured in Cavity Plasmon Resonance (CPR) configuration according to an embodiment of the current invention. For clarity, some elements already marked in previous drawings are unmarked in this drawing.

In this exemplary embodiment of CPR device, input channel is used as input port for fluid analyte flow. Fluid analyte may than exit through exit channel.

Reactive molecules 227, dispersed or dissolved analyte attach to receptors 228 attached to surface 229, thus affecting the optical properties of the device.

Preferably, reflected radiation 142 may be detected by optional reflected radiation 315.

### III. Optimization Procedure

As already noted, it is advantageous that R₁ also vanish in (5) to achieve total absorption. Utilizing (2), this term can be explicitly rewritten as

$${R}_{1} = \frac{{r}_{1} + {ρ}_{2} {e}^{i 2 {k}_{0} {dn}_{2} co s {θ}_{2}}}{1 + {r}_{1} {ρ}_{2} {e}^{i 2 {k}_{0} {dn}_{2} co s {θ}_{2}}} , \\ {ρ}_{2} = \frac{{N}_{2} - {N}_{3}^{\sim}}{{N}_{2} + {N}_{3}^{\sim}} \qquad ( 6 )$$

where the composite normalized refractive index N^{˜}₃, given via

$${N}_{3}^{\sim} = \{ \begin{matrix}i {N}_{3} cot ( {k}_{3} l cos {θ}_{3} ) , & CPR , Fig .1 ( c ) \\ {N}_{3} , & SPR , Fig .1 ( b )\end{matrix} \qquad ( 7 )$$

actually incorporates the effects of both the analyte and mirror layers in the CPR configuration, so that Eq. (6) expresses the well-known global reflectivity of a single slab [13], but with ρ₂ replacing r₂, i.e. N^{˜}₃ replacing N₃.

The actual biosensing procedure, i.e. measurement of the physical parameters (e.g. refractive index) of the analyte layer k₃, can be optimally facilitated by determining the conditions of total absorption of the incident radiation in the metallic film, leading to η=1 or R₁=0 in (5).

To clarify the current analytical formulation, we obtain explicit asymptotic expressions for the optimal absorbing film material as a function of its various parameters (thickness d, distance from the substrate Λ, angle of incidence θ₁, excitation frequency ω). Defining the normalized film thickness δ as

δ^{TE} ^{_{TM}}=k₁d cos ^{±1} θ₁, (8)

two asymptotic full absorption cases are of particular interest, namely, the limit of a thin film, i.e. δ<<1, and the limit for which the absorbing film cannot be considered as thin, i.e. δ˜1. Following the procedures described in [12], while requiring R₁=0 in (6), one obtains asymptotic expressions for the optimally absorbing film's impedance N_{2,opt} as

N_{2,opt}=(1+i)\sqrt{(1−N^{˜}₃)/(2δ)} (9)

and

N_{2,opt}=−N^{˜}₃(1+2e^{-2iδN}^{^{˜}}^{₃}^{-2/N}^{^{˜}}^{₃}) (10)

in the δ<<1 and δ˜1 limits, respectively.

Since the focus here is on metallic-type absorbing films, only the zero-order mode (m=0 in [12]) optimal asymptotic solution is provided here for the thin-film limit. Higher-order modes that provide appropriate optimal solutions supported by low loss (insulating) materials are not shown. Note that for the plasmon resonance condition, i.e. ℑ{N^{˜}₃}<0, Eqs. (9)-(10) hold equally for both TE and TM polarizations in the CPR case, whereas SPR is possible for TM polarization only.

For the thin film limit (δ<<1), the optimally absorbing film material, represented by N_{2,opt}, is highly dependent on its normalized distance from the substrate layer k₃Λ cos θ₃. For pπ≦k₃Λ cos θ₃<π/2+pπ, p=0, 1, 2, . . . , the loss angle of N_{2,opt} will be less than 45°, representing low loss materials with [symbol] {N₂}>>ℑ{N₂}. When k₃Λ cos θ₃=π/2+pπ, the loss angle of materials obeys the dispersion condition of good electric conductors, which corresponds to a loss angle of 45° (i.e., [symbol] {N_{2,opt}}=ℑ{N_{2,opt}}). However, lossy resonance excitation of materials in their conducting state with k₃Λ cos θ₃=π/2+pπ is usually not possible for infrared and shorter wavelengths. The reason is that, as the wavelength decreases, the dispersion of good conductors changes its behavior either into metallic-plasma-like state or anomalous absorption state whose loss angle deviates from the optimal 45°, thus making the optimal (η=1) excitation impossible. On the other hand, lossy resonance excitation is indeed possible also at much shorter wavelengths by using metals in their near-plasma band. One notes from (7)-(9) that for the thin film limit, if π/2+pπ<k₃Λ cos θ₃<(p+1) π, the optimal film is actually of a plasma type with its loss angle above 45°, since ℑ{N^{˜}₃}<0. Moreover, when the film becomes relatively thick (Eq. (10), δ˜1), the asymptotic optimal solutions are inherently of the plasmon resonance type. Their dispersion is that of metals in their plasma band with loss angle between 45° and 90°.

### IV. Results

The above conclusions are further demonstrated via FIG. 2 where the exact solutions of R₁=0 for either CPR (FIG. 1(h), setting θ₁=0) or SPR (FIG. 1(g)) are represented via optimal absorption paths [12] in the complex N₂ domain. This graphical method allows to find numerically the lossy resonance conditions in any given configuration. Along each path, the value of δ varies continuously for constant k₃Λ and θ₁, while the power absorption efficiency η in (5) is exactly 100%. It should be noted that the same path is obtained for either CPR or SPR, by properly setting k₃Λ and θ₁ to obtain identical N^{˜}₃ in (7). The relative refractive index of first layer was selected as to match common glasses used in SPR, i.e. k₁/kₒ=1.77 (k₀ is the wave-number in free space). For CPR, however, this value is quite arbitrary since no critical angle is required for its excitation and no specific restrictions are implied on the refractive indexes of different layers.

FIG. 2. depicts the optimal absorption paths (solid lines, A to E) for various total absorption cases (intersection points 1 to 6) along with some material dispersion [15] curves (dashed-dotted lines) in the complex N₂ domain for k₃/k₁=0.752 and k₁/k₀=1.77 (k₀ is the wave-number in free space). For the CPR configuration γ=k₃Λ cos θ₃, T₄=0, and θ₁=0 while for the SPR configuration [symbol] {N₃}=0 and θ₁>θ_{c}=sin⁻¹(k₃/k₁)=48.754°. Configuration parameters for the intersection points appear in Table 1.

Table 1. shows configuration parameters for intersection (full absorption) points, as depicted in FIGS. 2 and 3, respectively. The sensitivity and resolution are calculated as in [3].

FIG. 2 also depicts (dashed lines) the normalized dispersions of some noble metal materials (Table 1), versus the excitation frequency. The six intersection points between the optimal absorption paths and the material dispersion curves, for the specific metal being used, represent examples of conditions of full absorption or lossy resonance, thus providing the required optimal design values, i.e. the film thickness dₒₚₜ and excitation frequency ωₒₚₜ, per given substrate distance Λ or the angle of incidence θ₁. By looking at Table 1, one may indeed wonder whether having 43 nm cavity (case 1) is anyway feasible in practical implementation. However, the six cases were arbitrarily selected for demonstration purposes only, especially in order to provide some examples of the flexibility available in the CPR mode.

Another important aspect is what is the actual sensitivity that can be achieved using the above lossy resonance conditions. The power absorption efficiency in the vicinity of different intersection points (as shown in FIG. 2) is shown in FIG. 3 as a function of the excitation wavelength (FIG. 3(a)) and the incidence angle (FIG. 3(b)), subject to the precise configuration parameters (as given in Table 1).

For power absorption efficiency depicted in FIG. 3. the configuration details are given in Table 1 and material dispersions are taken from [15]. In FIG. 3(a), efficiency η is plotted versus excitation wavelength λ=c/f. In FIG. 3(b), efficiency η is plotted versus angle of incidence θ₁. The curve numbers here correspond to the full absorption (intersection) points as appear in FIG. 2 and Table 1.

The specific examples include CPR and SPR silver films excited in the visible band and gold or aluminum films excited in the near-infrared and ultraviolet bands. Evidently, both CPR and SPR absorption are inherently characterized by a high sensitivity in the frequency domain. For CPR, however, there is no critical angle or polarization involved in the excitation, thus as expected, it is much less sensitive to angle variations. On the other hand, the CPR excitation offers much more flexibility over wide ranges of wavelengths, bandwidths, and device dimensions, as can be concluded from Table 1. This is due to the fact that several additional free parameters exist in CPR as opposed to SPR. First, as already mentioned, there are no restrictions on the angle. Therefore, the excitation angle may vary from normal to grazing incidence, creating much greater selection of the optimal absorption configurations. This also relaxes the requirements for the refractive index of the first layer. In addition, if in theory the same optimal absorption paths can be implemented by either SPR or CPR, in reality the situation is different. While the substrate mirror can be freely moved to an arbitrary location, not all the critical angles from 0° to 90° degrees can be created for SPR. In fact, very limited range of critical angles can be created considering refractive indexes of materials available in nature.

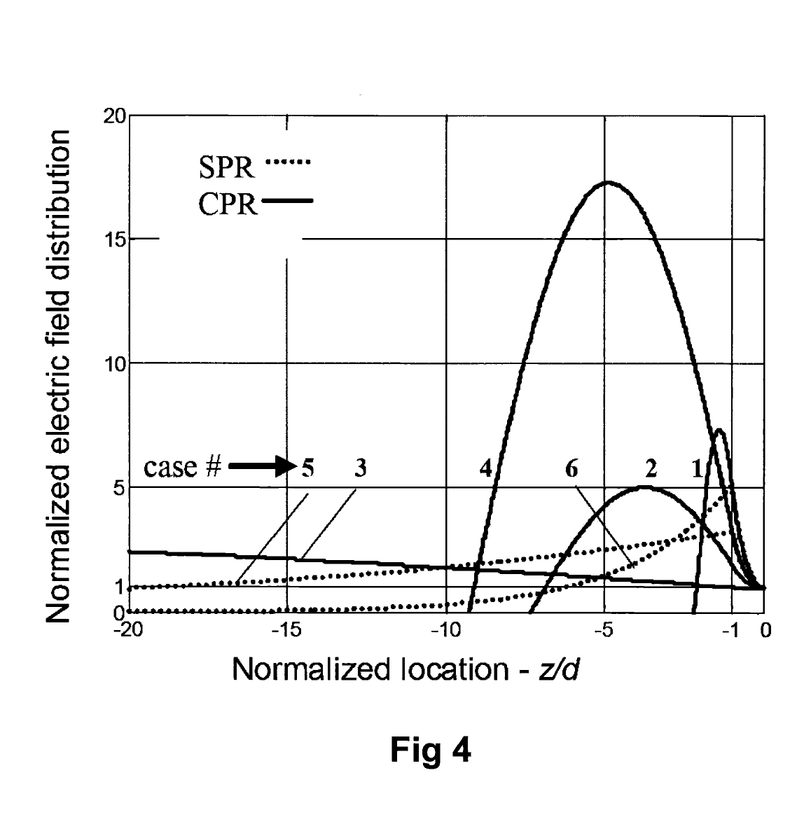

Another interesting observation can be made when looking at the normalized field distributions for both modes that can be calculated via Eqs. (1)-(4). Those are depicted in FIG. 4 for the six cases described in Table 1 and FIG. 2.

FIG. 4. depicts the normalized LRM field distributions E_{q}/Eᵢ (q=2,3) versus normalized location z/d. The curve numbers here correspond to the full absorption (intersection) points as appear in FIG. 2 and Table 1.

While the SPR field (dashed lines in FIG. 4) indeed attenuates exponentially with the distance away from the analyte-metal interface z=−d, the CPR field exhibits a cavity standing wave behavior in the region −Λ−d<z<−d with a peak field intensity accruing in the middle of the cavity, leading to a bulk volume field interaction with the analyte, rather than the surface-limited interaction associated with the SPR field.

### V. Discussion And Conclusions

Obviously, the optimal absorption cases shown in FIGS. 2-4 are not the only possible examples of the possible biosensing configurations and, as suggested by FIG. 2, many other intersection points exist, offering more flexibility in achieving full absorption in thin films over wide range of wavelengths, bandwidths, and device dimensions. Clearly, as compared to SPR, the CPR-supporting configurations ease the actual implementation of biosensing techniques due to the absence of specific critical angle and incoming wave polarization requirements. Moreover, only 4-layer configuration was considered herein, thus, the sensitivity limits of CPR can be further improved by inclusion of additional substrate layers.

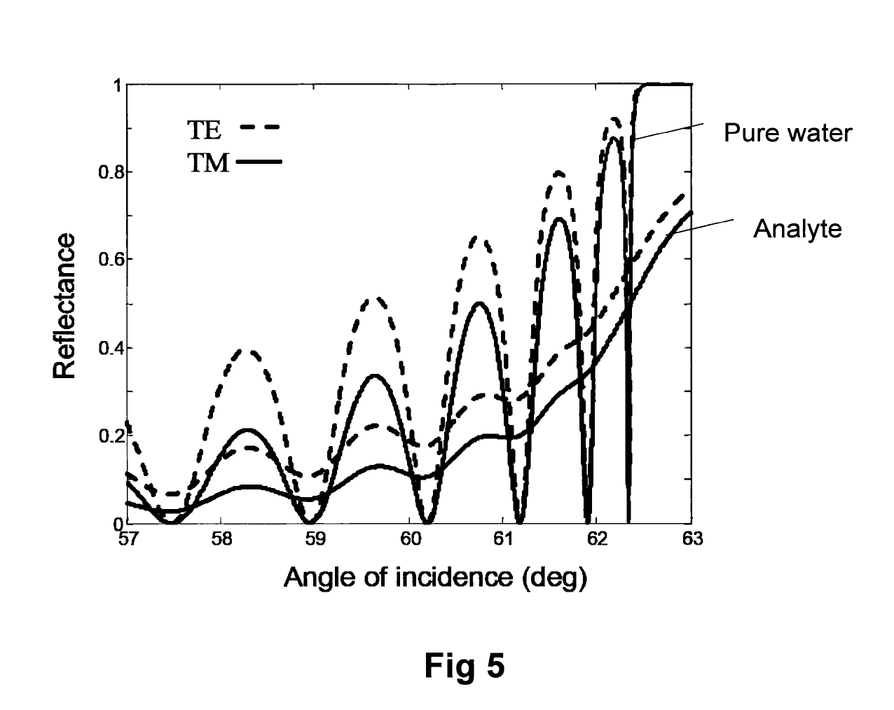

An interesting question may arise, on why is it necessary to consider maximal absorption as a means to obtain an ultrasensitive biosensing method. One alternative, yet less sensitive way, would be using non-resonant evanescent-wave methods, e.g. total internal reflection (TIR) spectroscopy instead of resonant absorption effects. Another approach would possibly be exploiting non-absorbing resonant effects in layered medium, e.g. Fabry-Perot-like interferometric methods. It turns out, however, that excitation of resonant modes in the latter way is challenging in the presence of even slightly lossy substances like water or biological samples. An attempt to perform high quality-factor sensing by exciting non-absorbing (non-LRM) resonant modes will usually lead to inadequate results. For example, the non-absorbing layered sensing configuration that was recently suggested in [16], will work well in case the analyte is lossless (FIG. 5) with high angle sensitivity in the reflectance spectra. However, once the analyte losses are accounted for, the resonant angle spectra readily breaks down, leaving completely smooth and senseless angle dependence (FIG. 5).

FIG. 5. shows the effect of analyte losses on the Fabry-Perot sensing configuration suggested in [16], demonstrated via angle dependent reflectivity. The “pure water” curves represent response of an idealized water (analyte), for which the losses were completely neglected, i.e. n₃=1.33. Inclusion of the actual (slight but evidently not negligible) water attenuation at the operating wavelength, i.e. n₃=1.33+i0.005, leads to elimination of the resonant behavior in the reflectance spectra (red curves).

For these reasons, including material losses in the optimization process is indeed crucial for the success of the method. Configurations resulting from the rigorous optimization process, presented herein, will demonstrate robust resonant performance even when varying analyte's losses since the only parameter that will be affected by this is the small imaginary part of N^{˜}₃ in Eqs. (6)-(10), having a negligible effect on the overall values of the power absorption efficiency in (5) and optimal absorbing film results in (9)-(10).

An additional important question is whether the indirect plasmon resonance sensing (via total absorption in the metal film) of the analyte can be replaced by a direct resonant excitation (maximal absorption) in the analyte layer itself. It turns out that highly sensitive refractometry is still possible using this alternative methodology but via excitation of low loss (high order, m>0) LRM in the microwave band, as was recently suggested in [12].

In conclusion, a new type of plasmon resonance excitation is proposed via excitation of thin metallic films utilizing the phenomenon of cavity plasmon resonance. The analytic derivation rendered closed-form formulae that allow characterization of optimal material (metal) dispersion, while assuring full absorption (no reflection) conditions for both the CPR and the SPR configurations. The performance of various CPR configurations was compared to those of the SPR, in both the frequency and the angular domains. The results of the current feasibility study suggest that CPR holds a great promise of becoming a very robust and flexible biosensing technique for ultrasensitive and robust refractive index measurements.

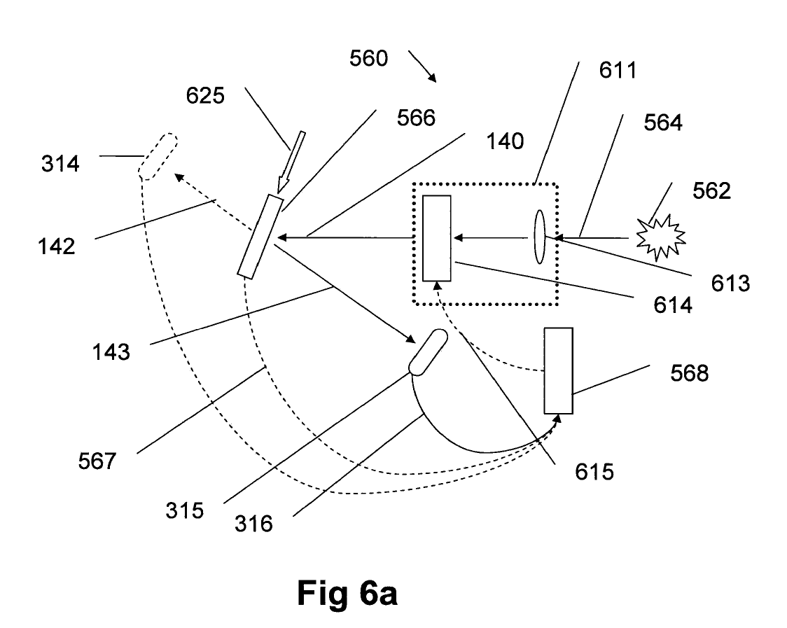

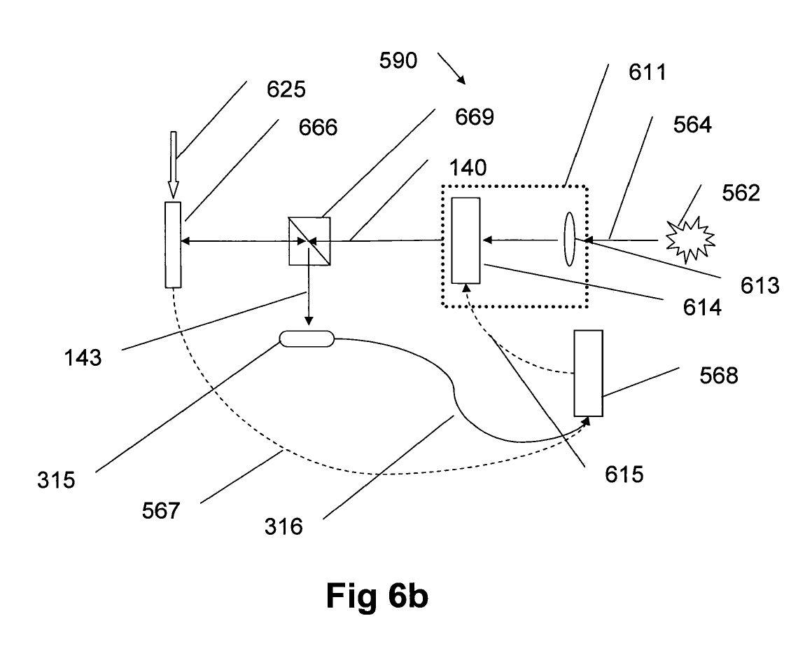

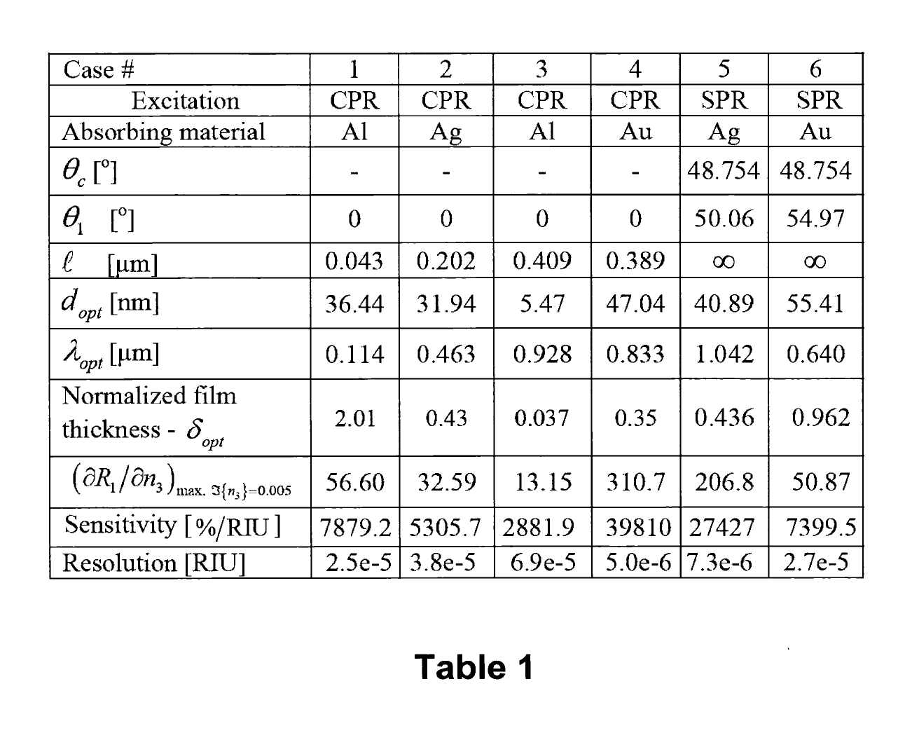

FIG. 6(a) schematically depicts an biosensing system 560 using a SPR or CRP microsensor 566 according to an aspect of the current invention.

Biosensing system 560 comprises a signal beam 564 emitted by radiation source 562.

Source 562 may be a broad band radiation such as an incandescent lamp. Alternatively the source may be a narrow wavelength source such as an LED. Optionally the source is a laser or plurality of lasers. Laser source may be a tunable laser such as dye laser. Optionally, solid state laser is used, for example laser diode such as Vertical Cavity Surface Emitting Laser (VCSEL).

Optionally, signal beam 564 traverses optical system 611 forming input radiation 140 which is detected by microsensor detector 566. Microsensor detector 566 may comprise a single microsensor element or an array of such elements.

Optical system 611 may comprise a beam forming optics 613 such as a beam collimating lens or lenses; polarizer; spatial filter; etc.

For a broad band radiation source, optional optical system 611 may comprise a wavelength selector 614 such as: grating, prism, interference filter, absorptive filter or tunable wavelength filter or a combination thereof as known in the art. Optional tunable filter is controlled by control channel 615. Alternatively, tunable source such as tunable laser may be used.

Additionally or alternatively, optical system 611 may comprise a time domain function such as: a chopper for affecting its transmittance; directional scanner; or combination thereof.

Alternatively, optical system 611 may be missing.

Analyte input 625 directs analyte at the microsensor or the array of microsensors 566.

Optional bolometric signal 567 indicative of absorbed portion of input radiation 140 is analyzed by data acquisition unit 568.

Reflected beam 143 is preferably detected by reflected radiation detector 315.

Optionally, transmitted beam 142 is preferably detected by transmitted radiation detector 314.

In some embodiments of the invention, an array of microsensors is used, wherein sensors in the array are prepared to detect or monitor specific substances. For example, different elements of the array may have different type of receptors 228 adopted to attach different types of molecules.

Additionally or alternatively, elements in the array may be differently constructed such that different elements are sensitive to different wavelength. In this embodiment, wavelength selectivity may be achieved by the sensor array instead of optical system 611 the use of a tunable source.

Additionally or alternatively, elements in the array may be differently constructed such that different elements are sensitive to different input beam direction. In this embodiment, selectivity may be achieved by the sensor array.

Identifying presence of an analyte may be achieved by scanning the wavelength of input radiation 140.

Finding a wavelength causing a maxima in the bolometric signal 567 may indicate the presence of an analyte. A movement in the wavelength of said maxima may indicate a change in analyte concentration.

Similarly, identifying presence of an analyte may be achieved by scanning the wavelength of input radiation 140 and finding a wavelength causing a minima in the reflected signal 316 which may indicate the presence of an analyte. A movement in the wavelength of said minima may indicate a change in analyte concentration.

Alternatively, a broad wavelength beam may be used with an array of elements each tuned to a slightly different wavelength. In this embodiment, an imaging unit (not drawn for clarity) may be used, imaging the reflected beam 143 on an array of detectors 315.

Similarly, an array of transmitted beam detectors 314 may be used.

Optionally, a combination of differently constructed elements may be used. Foe example, a 2D array wherein different type of receptors are used in different rows, and different configuration parameters, such as film thickness or gap width is used for different columns.

FIG. 6(b) schematically depicts a biosensing system 590 using a CRP microsensor 666 according to an aspect of the current invention.

According to this embodiment of the invention, a beam splitter 669 is used for splitting the reflected beam 143 from input beam 140 and direct said reflected beam to detector 315.

evices, methods and systems according to the general scope of the current invention may be used to detect and/or monitor presence and concentration of specific substances in fluids, for example: contaminants in drinking water; pollutants in air, vitamins, hormones or enzymes and other substances in bodily fluids such as blood or saliva; etc.

The term “bio” “biosensor” and “biosensing” should not be used as limiting the invention. Devices, methods and systems according to the general scope of the current invention may be used to detect and/or monitor inorganic material as well as organic materials of non-biological origin.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A stratified sensor for monitoring analyte comprising:
a substrate;
an absorbing film for absorbing incoming radiation by excitation of plasmon in said absorbing film, and converting said absorbed radiation to heat, wherein plasmon resonance absorption of said radiation increases the fraction of radiation absorption by at least ten percents,
wherein said substrate and said absorbing film are separated by a gap into which fluid analyte is inserted.

2. The stratified sensor of claim 1 wherein gap between the absorbing film and the substrate acts as a resonance cavity.

3. The stratified sensor of claim 2 and further comprising a reflector deposited on front surface of the substrate.

4. The stratified sensor of claim 1 and further comprising a substantially transparent prism attached to the front surface of the absorbing film.

5. The stratified sensor of claim 1 wherein plasmon resonance absorption increases the fraction of radiation absorption to at least ninety percents.

6. The stratified sensor of claim 5 wherein plasmon resonance absorption increase is over a narrow range of wavelength.

7. The stratified sensor of claim 5 wherein plasmon resonance absorption increase is over a narrow range incoming beam angulations.

8. The stratified sensor of claim 1 wherein absorbing film comprises material selected from the group of: vanadium dioxide, bismuth, carbon, tellurium; silver; gold; aluminum; and copper.

9. The stratified sensor of claim 1 wherein receptors for attaching molecules dissolved in analyte are deposited on the surface of the absorbing film.

10. A method for monitoring analyte comprising the step of:
inserting analyte in a gap between a substrate and an absorbing film;
resonantly exciting plasmons in said absorbing film by absorbing electromagnetic radiation; and
detecting signal indicative of said absorbed radiation.

11. The method for monitoring analyte of claim 10 wherein the step of detecting signal indicative of absorbed radiation comprises measuring temperature increase of the absorbing film caused by said absorbed radiation.

12. The method for monitoring analyte of claim 10 wherein the step of detecting signal indicative of absorbed radiation comprises measuring radiation which was not absorbed.

13. The method for monitoring analyte of claim 12 wherein the step of measuring radiation which was not absorbed comprises measuring reflected radiation.

14. An biosensing system for monitoring analyte comprising:
at least one stratified sensor comprising:
a substrate;
an absorbing film for absorbing incoming radiation by excitation of plasmon in said absorbing film, and converting said absorbed radiation to heat, wherein plasmon resonance absorption of said radiation increases the fraction of radiation absorption by at least ten percents,
wherein said substrate and said absorbing film are separated by a gap into which fluid analyte is inserted;
a radiation source for generating said incoming radiation; and
data acquisition unit receiving signals from said at least one stratified sensor.

15. The biosensing system of claim 14 and further comprising an array of stratified sensors.

16. The biosensing system of claim 15 wherein array of stratified sensors comprises of substantially unequal sensors.

17. The biosensing system of claim 16 wherein the substantially unequal sensors are responsive to different narrow wavelength ranges.

18. The biosensing system of claim 16 wherein the substantially unequal sensors are responsive to different analytes.

19. The biosensing system of claim 18 wherein the substantially unequal sensors comprises different receptors responsive to different analytes.
